(19) United States
(12) Patent Application Publication
(10) Pub. No.: US 2014/0315547 A1
(43) Pub. Date: Oct. 23, 2014

(54) ELECTRONIC DEVICE AND METHOD FOR PROCESSING SCAN RESULTS

(71) Applicant: FIH (HONG KONG) LIMITED, KOWLOON (HK)

(72) Inventor: YI-CHUN YU, New Taipei (TW)

(73) Assignee: FIH (HONG KONG) LIMITED, KOWLOON (HK)

(21) Appl. No.: 14/257,087

(22) Filed: Apr. 21, 2014

(30) Foreign Application Priority Data
Apr. 23, 2013 (TW) 102114489

(51) Int. Cl. H04W 40/24; G06F 3/041

(52) U.S. Cl. CPC H04W 40/248; G06F 3/041
USPC 455/434

(57) ABSTRACT

A method for processing a scan result detects a floating touch signal of the electronic device when a scanning module searches for networks or other electronic devices. The method further displays a current scan result acquired from the scanning unit on a display device. The method further determines an updated scan result at a predetermined interval. When the floating touch signal is detected when the updated scan result is different from the current scan result, the method maintains the current scan result displayed on the display device and determines a difference result between the updated scan result and the current scan result. The difference result is displayed on a designated region of the display device.

### FIELD

Embodiments of the present disclosure relate to connection scan technology, and particularly to an electronic device and method for processing scan results using the electronic device.

### BACKGROUND

A scanning unit in an electronic device (e.g., a mobile device) can search for networks or other electronic devices that are available to be connected to by the electronic device. A scan result displayed on a display device of the electronic device can be updated in real time, and a list of the scan result can be refreshed continuously. A user may use a floating touch technology to select a target network or a target electronic device from the scan result without touching the display device directly. However, because the list of the scan result may be refreshed continuously, a target network or target electronic device may not be selected accurately and conveniently when the scan result is refreshing.

### BRIEF DESCRIPTION OF THE DRAWINGS

Implementations of the present disclosure will now be described, by way of example only, with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views.

FIG. 1 is a schematic diagram of one embodiment of an electronic device including a scan result processing system.

FIG. 2 is a block diagram of one embodiment of function modules of the scan result processing system of the electronic device in FIG. 1.

FIG. 3 is a schematic diagram of an embodiment of operations of the scan result processing system in FIG. 2.

FIG. 4 is another schematic diagram of operations of the scan result processing system in FIG. 2.

FIG. 5 is a first schematic diagram of an embodiment of a scan result of the scan result processing system.

FIG. 6 is a second schematic diagram of the scan result of the scan result processing system.

FIG. 7 is a flowchart of one embodiment of a method for processing the scan result using the electronic device of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references can mean “at least one,” or “one or more.”

In the present disclosure, “module,” refers to logic embodied in hardware or firmware, or to a collection of software instructions, written in a program language. In one embodiment, the program language can be Java, C, or assembly. One or more software instructions in the modules can be embedded in firmware, such as in an EPROM. The modules described herein can be implemented as either software and/or hardware modules and can be stored in any type of non-transitory computer-readable media or storage medium. Non-limiting examples of a non-transitory computer-readable medium include CDs, DVDs, flash memory, and hard disk drives.

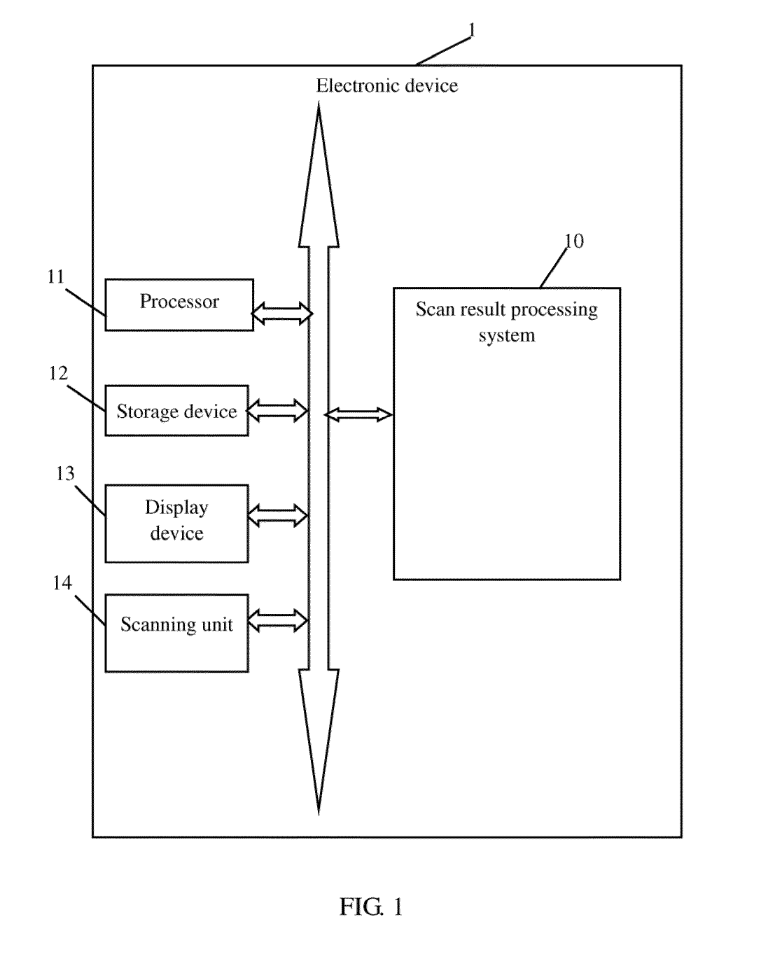

FIG. 1 is a block diagram of one embodiment of an electronic device 1 including a scan result processing system 10. In one embodiment, the electronic device 1 may be a mobile phone, a tablet computer, a notebook computer, a personal digital assistant (PDA), a mobile Internet device (MID), or any other electronic devices. The electronic device 1 can include at least one processor 11, a storage device 12, a display device 13, and a scanning unit 14. The at least one processor 11 executes one or more computerized codes and other applications of the electronic device 1, to provide functions of the scan result processing system 10. The storage device 12 may be a memory of the electronic device 1 or an external storage card, such as a smart media card or a secure digital card.

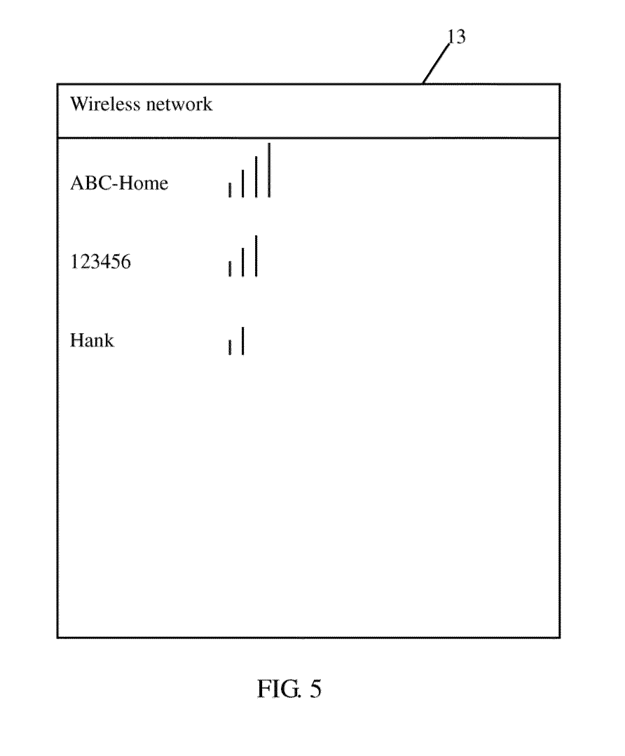

The display device 13 can display visible data, such as images and videos. In one embodiment, the display device 13 can support operations of a floating touch technology. The scanning unit 14 may search for networks (e.g. a wireless network) or other electronic devices (e.g. devices having BLUETOOTH™ modules), which are available to be connected to by the electronic device 1. As shown in FIG. 5, three wireless networks have been searched by the scanning unit 14, and names of users or devices of the three wireless networks are displayed on the display device 13. The scanning unit 14 may search for the networks or other electronic devices in real-time or at a predetermined time interval (e.g. 5 seconds).

In one embodiment, the scan result processing system 10 can detect a floating touch signal of the electronic device 1, and optimize a scan result scanned by the scanning unit 14 according to the floating touch signal.

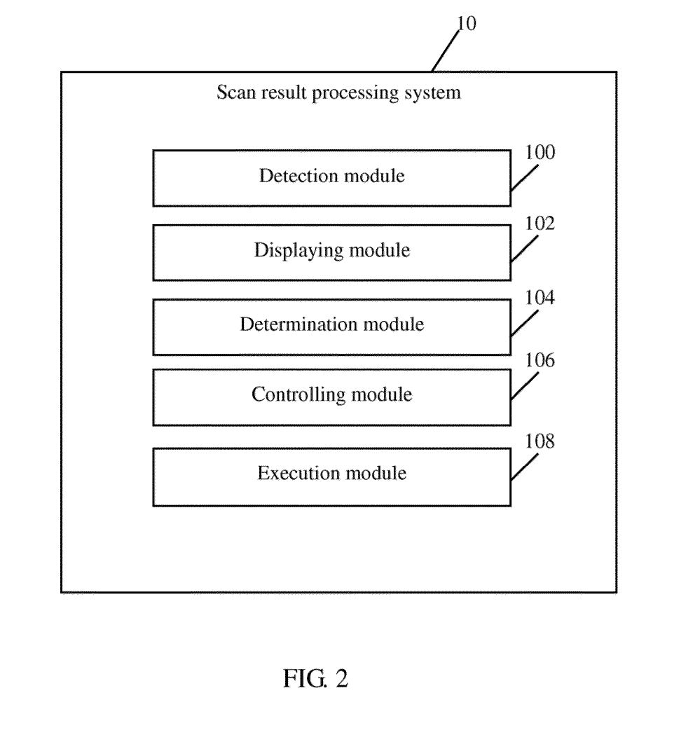

FIG. 2 is a block diagram illustrating function modules of the scan result processing system 10. In this embodiment, the scan result processing system 10 includes a detection module 100, a displaying module 102, a determination module 104, a controlling module 106, and an execution module 108. The modules 100, 102, 104, 106, and 108 include computerized code in the form of one or more programs that are stored in the storage device 12. The computerized code includes instructions that are executed by the at least one processor 11 to provide functions of the scan result processing system 10. A description of each module of the scan result processing system 10 is given in the following paragraphs.

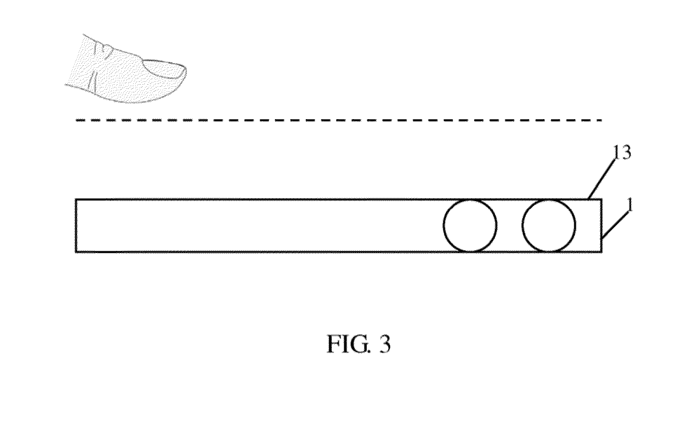

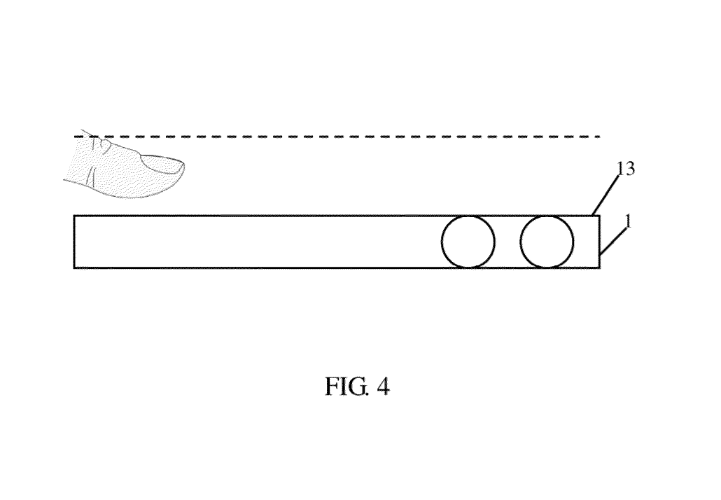

The detection module 100 can detect a floating touch signal of the electronic device when the scanning module 14 is enabled to search for the networks or the other electronic devices that are available to be connected to by the electronic device 1. In one embodiment, the floating touch signal is detected within a predetermined distance (e.g. 20 millimeters) from the display device 13. As shown in FIG. 3, a distance between a dotted line and a plane of the display device 13 represents the predetermined distance. In FIG. 3, a finger of a user is out of range of the predetermined distance. In FIG. 4, the finger is within range of the predetermined distance, so the floating touch signal can be detected.

The displaying module 102 can display a current scan result acquired from the scanning unit 14 on the display device 13. As shown in FIG. 5, the current scan result including three searched networks is displayed. The current scan result is updated/refreshed after each predetermined time interval. In one embodiment, when the scanning unit 14 obtains an updated scan result while the floating touch signal is not detected, the displaying module 102 displays the updated scan result on the display device 13 to replace the current scan result.

When the scanning unit 14 obtains an updated scan result while the floating touch signal is detected, the determination module 104 can determine whether the updated scan result is the same as the current scan result.

When the floating touch signal is detected and the updated scan result is the same as the current scan result, the control module 106 can maintain the current scan result displayed on the display device 13.

When the floating touch signal is detected and the updated scan result is different from the current scan result, the control module 106 can maintain the current scan result displayed on the display device 13 and determines a difference result between the updated scan result and the current scan result.

The displaying module 102 can display the difference result on a designated region of the display device 13. The designated region is adjacent to a region that displays the current scan result. For example, the adjacent area may be on the top/bottom/left/right of the region of the current scan result.

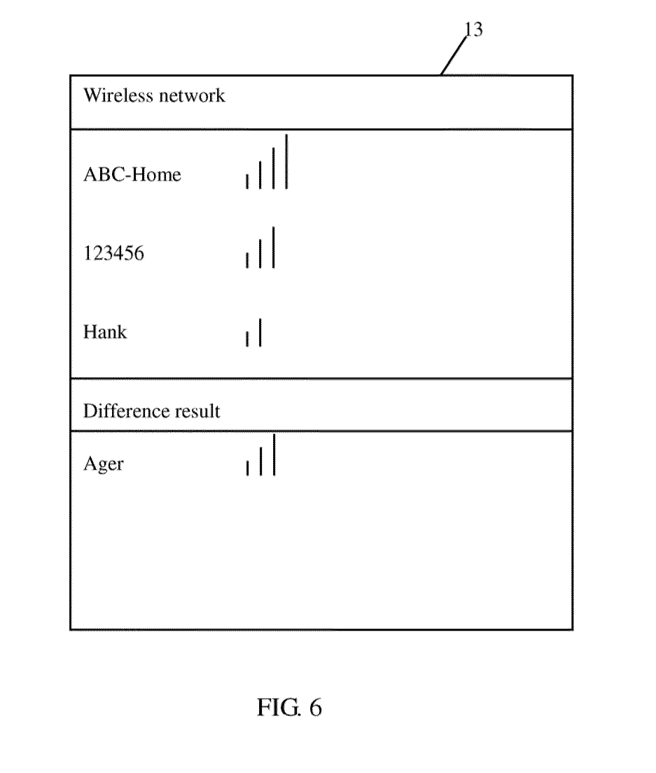

As shown in FIG. 6, the determination module 104 can determine a network named “Ager” as the difference result. The displaying module 102 displays the current scan result and the difference result on the display device 13.

In one embodiment, when the current scan result includes data that is not included in the updated scan result (hereinafter “the inexistent data”), the control module 106 further deletes the inexistent data from the current scan result.

In other embodiments, the execution module 108 can connect the electronic device 1 to a corresponding network or other electronic device selected by the user in response to the floating touch signal.

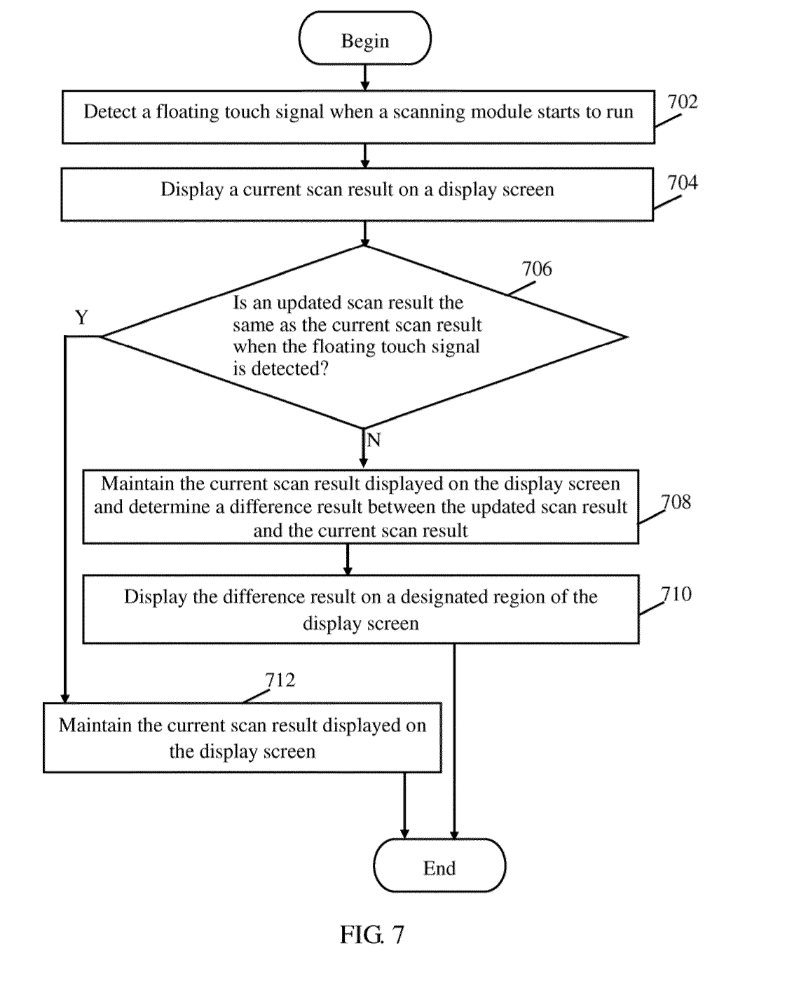

FIG. 7 is a flowchart of one embodiment of a method for processing a scan result using the electronic device 1. Depending on the embodiment, additional blocks may be added, others removed, and the ordering of the blocks may be changed.

In block 702, the detection module 100 detects a floating touch signal of the electronic device when the scanning module 14 is enabled to search for the networks or the other electronic devices.

In block 704, the display module 102 displays a current scan result acquired from the scanning unit 14 on the display device 13.

In block 706, the determination module 104 determines an updated scan result and determines whether the updated scan result is the same as the current scan result, when the floating touch signal is detected. If the updated scan result is determined to be the same as the current scan result, 712 is implemented. If the updated scan result is determined to be different from the current scan result, 708 is implemented

In block 708, the control module 106 maintains the current scan result displayed on the display device 13, and determines a difference result between the updated scan result and the current scan result.

In block 710, the displaying module 102 displays the difference result on a designated region of the display device 13, and the procedure ends.

In block 712, the control module 106 maintains the current scan result displayed on the display device 13, and the procedure ends.

All of the processes described above may be embodied in, and fully automated via, functional code modules executed by one or more general purpose processors such as the processor 11. The code modules may be stored in any type of non-transitory readable medium or other storage device such as the storage device 12. Some or all of the methods may alternatively be embodied in specialized hardware. Depending on the embodiment, the non-transitory readable medium may be a hard disk drive, a compact disc, a digital versatile disc, a tape drive, or other suitable storage medium.

The described embodiments are merely examples of implementations, and have been set forth for a clear understanding of the principles of the present disclosure. Variations and modifications may be made without departing substantially from the spirit and principles of the present disclosure. All such modifications and variations are intended to be included within the scope of this disclosure and the described inventive embodiments, and the present disclosure is protected by the following claims and their equivalents.

What is claimed is:

1. A method for processing a scan result using an electronic device, the electronic device comprising a scanning unit and a display device, the method comprising:
detecting a floating touch signal of the electronic device when the scanning module is enabled to search for networks or other electronic devices which are available to be connected by the electronic device;
displaying a current scan result acquired from the scanning unit on the display device;
determining an updated scan result, and determining whether the updated scan result is the same as the current scan result when the floating touch signal is detected;
maintaining the current scan result displayed on the display device;
determining a difference result between the updated scan result and the current scan result, when the updated scan result is different from the current scan result; and
displaying the difference result on a designated region of the display device.

2. The method according to claim 1, further comprising:
displaying the updated scan result on the display device for replacing the current scan result, when the floating touch signal is not detected and the updated scan result is different from the current scan result.

3. The method according to claim 1, further comprising:
deleting inexistent data which is not existed in the updated scan result from the current scan result, when the current scan result comprises the inexistent data and the updated scan result does not comprise the inexistent data.

4. The method according to claim 1, further comprising:
maintaining the current scan result displayed on the display device when the updated scan result is the same as the current scan result.

5. The method according to claim 1, wherein the scanning unit searches for the networks or the other electronic devices at a predetermined time interval, and the floating touch signal is detected within a predetermined distance from the display device.

6. The method according to claim 1, wherein the designated region is adjacent to a region that displays the current scan result.

7. An electronic device, the electronic device comprising a scanning unit and a display device, the network comprising:
at least one processor; and
a storage device storing one or more programs, when executed by the at least one processor, cause the at least one processor to perform operations of:
detecting a floating touch signal of the electronic device when the scanning module is enabled to searching for networks or other electronic devices which are available to be connected by the electronic device;
displaying a current scan result acquired from the scanning unit on the display device;
determining an updated scan result, and determining whether the updated scan result is the same as the current scan result when the floating touch signal is detected;
maintaining the current scan result displayed on the display device and determining a difference result between the updated scan result and the current scan result, when the updated scan result is different from the current scan result; and
displaying the difference result on a designated region of the display device.

8. The electronic device according to claim 7, further comprising:
displaying the updated scan result on the display device for replacing the current scan result, when the floating touch signal is not detected and the updated scan result is different from the current scan result.

9. The electronic device according to claim 7, further comprising:
deleting inexistent data which is not existed in the updated scan result from the current scan result, when the current scan result comprises the inexistent data and the updated scan result does not comprise the inexistent data.

10. The electronic device according to claim 7, further comprising:
maintaining the current scan result displayed on the display device when the updated scan result is the same as the current scan result.

11. The electronic device according to claim 7, wherein the scanning unit searches for the networks or the other electronic devices at a predetermined time interval, and the floating touch signal is detected within a predetermined distance from the display device.

12. The electronic device according to claim 7, wherein the designated region is adjacent to a region that displays the current scan result.

13. A non-transitory storage medium having stored thereon instructions that, when executed by at least one processor of an electronic device, cause the processor to perform a method for expanding storage space using the electronic device, the electronic device comprising a scanning unit and a display device, the method comprising:
detecting a floating touch signal of the electronic device when the scanning module is enabled to searching for networks or other electronic devices which are available to be connected by the electronic device;
displaying a current scan result acquired from the scanning unit on the display device;
determining an updated scan result, and determining whether the updated scan result is the same as the current scan result when the floating touch signal is detected;
maintaining the current scan result displayed on the display device and determining a difference result between the updated scan result and the current scan result, when the updated scan result is different from the current scan result; and
displaying the difference result on a designated region of the display device.

14. The storage medium according to claim 13, further comprising:
displaying the updated scan result on the display device for replacing the current scan result, when the floating touch signal is not detected and the updated scan result is different from the current scan result.

15. The storage medium according to claim 13, further comprising:
deleting inexistent data which is not existed in the updated scan result from the current scan result, when the current scan result comprises the inexistent data and the updated scan result does not comprise the inexistent data.

16. The storage medium according to claim 13, further comprising:
maintaining the current scan result displayed on the display device when the updated scan result is the same as the current scan result.

17. The storage medium according to claim 13, wherein the scanning unit searches for the networks or the other electronic devices at a predetermined time interval, and the floating touch signal is detected within a predetermined range from the display device.

18. The storage medium according to claim 13, wherein the designated region is adjacent to a region that displays the current scan result.
